(19) United States
(12) Patent Application Publication
(10) Pub. No.: US 2019/0020720 A1
(43) Pub. Date: Jan. 17, 2019

(54) CLOUD-BASED SYSTEM AND METHOD FOR MANAGING ENTERTAINMENT PARKS

(71) Applicant: Aluvii, Inc., Provo, UT (US)

(72) Inventor: Michael Stahle, Salt Lake City, UT (US)

(21) Appl. No.: 15/689,820

(22) Filed: Aug. 29, 2017

Related U.S. Application Data
(60) Provisional application No. 62/533,551, filed on Jul. 17, 2017.

(51) Int. Cl. H04L 29/08

(52) U.S. Cl. CPC H04L 67/125; H04L 67/10; H04L 67/02

(57) ABSTRACT

A system for remotely controlling a peripheral device, the system comprising a management server having a processor and memory, the memory comprising computer-readable instructions that, when executed by the processor, cause the processor to: (i) receive a command to control the peripheral device over a network from an originating gateway device; (ii) process the command to determine a destination gateway device for the command, the destination gateway device being connected to the peripheral device; (iii) select between one of a first communication protocol and a second communication protocol based upon one of a stability and latency of a network connection between the management server and the destination gateway device; (iv) routing the command to the destination gateway device over the network using the selected one of the first communication protocol and the second communication protocol.

### CROSS-REFERENCE TO RELATED APPLICATIONS

This application claims the benefit of U.S. Provisional Patent Application No. 62/533,551 filed on Jul. 17, 2017, which application is hereby incorporated herein by reference in its entirety.

### STATEMENT REGARDING FEDERALLY SPONSORED RESEARCH OR DEVELOPMENT

Not Applicable.

### BACKGROUND OF THE INVENTION

### 1. The Field of the Invention

This invention relates generally to systems and methods of remotely managing hardware used in amusement parks.

### 2. Description of Related Art

Cloud computing is a form of Internet-based computing that provides shared computer processing resources and data to computers and other devices on demand. It is a model for enabling ubiquitous, on-demand access to a shared pool of configurable computing resources (e.g., computer networks, servers, storage, applications and services), which can be rapidly provisioned and released with minimal management effort. Basically, cloud computing allows the users and enterprises with various capabilities to store and process their data in either privately owned cloud, or on a third-party server in order to make data accessing mechanisms much more easy and reliable. Data centers that may be located far from the user—ranging in distance from across a city to across the world. Cloud computing relies on sharing of resources to achieve coherence and economy of scale, similar to a utility (like the electricity grid) over a power distribution network.

Solutions for managing amusement parks have traditionally been single-task oriented and limited to localized computer servers. Further, many amusement parks still utilize outdated technology on legacy hardware and peripheral devices that may date back twenty or more years. Because it is often times cost prohibitive for amusement parks to upgrade their hardware and peripheral devices, it has been difficult in the past to integrate these outdated systems with newer technology. The present disclosure eliminates many of the drawbacks found in the prior art and provides novel solutions to common problems facing amusement park owners through the use of a cloud-based park management system that does not require the replacement of outdated hardware and peripheral devices.

### BRIEF DESCRIPTION OF THE DRAWINGS

The features and advantages of the disclosure will become apparent from a consideration of the subsequent detailed description presented in connection with the accompanying drawings in which:

FIG. 1 is a diagram of a cloud-based architecture of a park management system according to an embodiment of the present disclosure;

FIG. 2 is a diagram of a park management server and park operational hardware according to an embodiment of the present disclosure;

FIG. 3 is a diagram of a park management server in relation to a plurality of park gateway devices according to an embodiment of the present disclosure;

FIG. 4 depicts a process for assigning a gateway ID to a park gateway device;

FIG. 5 depicts a process for assigning a peripheral device for the execution of commands;

FIG. 6 depicts a process for routing a command from a park gateway device to the assigned peripheral device; and

FIG. 7 depicts a process for sharing peripheral devices for failover protection.

### DETAILED DESCRIPTION

For the purposes of promoting and understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

In describing and claiming the present disclosure, the following terminology will be used in accordance with the definitions set out below. As used in this specification and the appended claims, the singular forms “a,” “an,” and “the” include plural referents unless the context clearly dictates otherwise. As used herein, the terms “comprising,” “including,” “containing,” “characterized by,” “having,” and grammatical equivalents thereof are inclusive or open-ended terms that do not exclude additional, unrecited elements or method steps.

It will be appreciated that as used herein, the terms “entertainment park” or “park” refers to indoor and outdoor enterprises with rides, features, shows, performances, events, concerts, competitions, sporting events, attractions, refreshments, games of chance or skill, and other entertainments. As used herein, the terms “amusement park” or “park” shall be further understood to include water parks, theme parks, amusement parks, museums, concert venues, stadiums, arenas, halls, performance places, studios, parks, event venues, theatres, ski areas, family fun centers, restaurants, water parks, zoos & aquariums and other entertainment locations. As used herein, the terms “amusement park” or “park” shall be further understood to include locals with points of sale that utilize one or more computing devices to perform transactions with guests, consumers or visitors (hereinafter collectively “guests”) and that are connected to peripheral devices.

As used herein, the term “peripheral device” is an ancillary device used to put information into and get information out of a local computing device, usually located at a POS. According to the present disclosure, peripheral devices may include printers, digital cameras, receipt printers, bar code readers, cash drawers, access controls, credit card readers, ticket printers, and the like. A peripheral device may be connected to a local computing device, sometimes referred to herein as a gateway device, through a communications port, such as a serial port or a parallel port.

The present invention will now be described more fully hereinafter with reference to the accompanying drawings, which illustrate embodiments of the invention. This invention may, however, be embodied in many different forms and should not be construed as limited to the illustrated embodiments set forth herein. Rather, these embodiments are provided so that this disclosure will be thorough and complete, and will fully convey the scope of the invention to those skilled in the art.

It is an objective of the present disclosure to provide an improved system and method for managing entertainment parks using a cloud-based park management server having a processor and a memory, wherein the memory comprises a park management program having instructions that are executable on the processor to provide improved park management.

It is an objective of the present disclosure to provide an improved system and method for managing entertainment parks in a cloud-based environment, including a cloud-based park management server having a processor and a memory, wherein the memory comprises a park management program having instructions that are executable on the processor operable to provide improved gift card management, product lookup, loyalty programs, order modification, discount package management, and improved report generation.

It is an objective of the present disclosure to provide an improved system and method for managing entertainment parks in a cloud-based environment, including a cloud-based park management server having a processor and a memory, wherein the memory comprises a park management program having instructions that are executable on the processor operable to provide cloud-based support for a wide range of peripheral devices, including cash drawers and receipt printers.

It is an objective of the present disclosure to provide an improved system and method for managing entertainment parks in a cloud-based environment, including a cloud-based park management server having a processor and a memory, wherein the memory comprises a park management program having instructions that are executable on the processor operable to provide improved e-ticketing solutions and that integrates seamlessly with built-in e-commerce, point of sale (“POS”) and access control modules.

It is an objective of the present disclosure to provide an improved system and method for managing entertainment parks in a cloud-based environment, including a cloud-based park management server having a processor and a memory, wherein the memory comprises a park management program having instructions that are executable on the processor operable to provide fully customizable templates.

It is an objective of the present disclosure to provide an improved system and method for managing entertainment parks in a cloud-based environment, including a cloud-based park management server having a processor and a memory, wherein the memory comprises a park management program having instructions that are executable on the processor operable to provide access control that allows any ticket to be validated from any access point.

It is an objective of the present disclosure to provide an improved system and method for managing entertainment parks in a cloud-based environment, including a cloud-based park management server having a processor and a memory, wherein the memory comprises a park management program having instructions that are executable on the processor operable to provide ticket groups—perfect for parties, bulk printing, and employee accountability.

It is an objective of the present disclosure to provide an improved system and method for managing entertainment parks in a cloud-based environment, including a cloud-based park management server having a processor and a memory, wherein the memory comprises a park management program having instructions that are executable on the processor operable to provide e-ticketing solutions.

It is an objective of the present disclosure to provide an improved system and method for managing entertainment parks in a cloud-based environment, including a cloud-based park management server having a processor and a memory, wherein the memory comprises a park management program having instructions that are executable on the processor operable to provide reporting that tracks usage, consumption, and breakage all in real time.

It is an objective of the present disclosure to provide an improved system and method for managing operational hardware of entertainment parks in a cloud-based environment, including a cloud-based park management server having a processor and a memory, wherein the memory comprises a park management program having instructions that are executable on the processor operable to provide hardware interfacing to print tickets on the fly.

It is an objective of the present disclosure to provide an improved system and method for managing operational hardware of entertainment parks in a cloud-based environment, including a cloud-based park management server having a processor and a memory, wherein the memory comprises a park management program having instructions that are executable on the processor operable to provide improved e-commerce, including: offering products or membership that can be sold online, reservation management, e-ticketing, voucher codes, and purchase history.

It is an objective of the present disclosure to provide an improved system and method for managing operational hardware of entertainment parks in a cloud-based environment, including a cloud-based park management server having a processor and a memory, wherein the memory comprises a park management program having instructions that are executable on the processor operable to provide digital passes (passes and tickets can be accessed and scanned digitally), image upload, account access, membership purchases, and membership management.

It is an objective of the present disclosure to provide an improved system and method for managing entertainment parks in a cloud-based environment, including a cloud-based park management server having a processor and a memory, wherein the memory comprises a park management program having instructions that are executable on the processor operable to provide improved RFID, including: RFID admissions and e-ticketing (provides member access and admission), keyless entry (secure entry access to doors and lockers), line queue control (manage lines and crowd control), and cashless POS (provides pre-pay access to arcade, food, and attractions), guest, employee ID and tracking.

It is an objective of the present disclosure to provide an improved system and method for managing operational hardware of entertainment parks in a cloud-based environment, including a cloud-based park management server having a processor and a memory, wherein the memory comprises a park management program having instructions that are executable on the processor operable to provide improved membership management, including: split and merge accounts (split one account into two or merge two accounts into one), customize templates and print membership cards on the fly using peripheral devices, renewals (renewing guest memberships is as easy as checking a box), shared memberships (allow guests on an account to share any membership(s)), and a guest website portal (a guest-facing portal tied directly to their account for self-management).

It is an objective of the present disclosure to provide an improved system and method for managing operational hardware of entertainment parks in a cloud-based environment, including a cloud-based park management server having a processor and a memory, wherein the memory comprises a park management program having instructions that are executable on the processor operable to provide improved event management, including: flexibility (capable of handling any reservation or event bookings to match your needs), online reservations and booking (allows guests to make reservations and bookings online from any device), e-ticketing, set and manage event capacity limits (set capacity limits to prevent overselling events), and ticket type management (set up multiple ticket types with different pricing and quantity per event).

It is an objective of the present disclosure to provide an improved system and method for managing operational hardware of entertainment parks in a cloud-based environment, including a cloud-based park management server having a processor and a memory, wherein the memory comprises a park management program having instructions that are executable on the processor operable to provide improved inventory management, including: real-time inventory tracking, location tracking (keep track of inventory levels in real time), inventory reorder management (avoid stockouts by setting reorder points by product), and physical counts (counting inventory made easy with mobile-friendly forms).

It is an objective of the present disclosure to provide an improved system and method for managing operational hardware of entertainment parks in a cloud-based environment, including a cloud-based park management server having a processor and a memory, wherein the memory comprises a park management program having instructions that are executable on the processor operable to provide improved limited liability waiver management, including: e-signatures (sign waivers using a mouse or finger on any device), quick lookup (look up waivers for quick verification), PDF download (when occasion arises, download any signed waiver as a PDF), text editor (include any custom waiver language with full editor), and full integration with membership management and customer database.

It is an objective of the present disclosure to provide an improved system and method for managing operational hardware of entertainment parks in a cloud-based environment, including a cloud-based park management server having a processor and a memory, wherein the memory comprises a park management program having instructions that are executable on the processor operable to provide improved interfacing with third-party hardware, including: print anywhere functionality (control and use your devices remotely from anywhere in the world), hardware sharing (share devices among staff reducing the need for more hardware), auto detection (auto-detect devices allowing for easy set up and usability), and single view (view all company devices and statuses from one simple interface).

It is an objective of the present disclosure to provide an improved system and method for managing operational hardware of entertainment parks in a cloud-based environment, including a cloud-based park management server having a processor and a memory, wherein the memory comprises a park management program having instructions that are executable on the processor operable to provide online marketing management, including: automated campaigns (set up unlimited scheduled campaigns to specific customer sets), custom templates (create mobile-responsive email templates with easy-to-use editor), target customers (filter your customer list to hit the right customer segment), and template customization (personalize messaging using fillable templates).

It is an objective of the present disclosure to provide an improved system and method for managing operational hardware of entertainment parks in a cloud-based environment, including a cloud-based park management server having a processor and a memory, wherein the memory comprises a park management program having instructions that are executable on the processor operable to provide improved asset management, including: set asset status, (create custom statuses and mark against any asset), employee checkout (assign employees to check out equipment for better tracking), asset typing (categorize each asset by type for better grouping and organization), and location (separate and locate equipment using location settings).

It is an objective of the present disclosure to provide an improved system and method for managing operational hardware of entertainment parks in a cloud-based environment, including a cloud-based park management server having a processor and a memory, wherein the memory comprises a park management program having instructions that are executable on the processor operable to provide improved HR management, time keeping, shift management, and employee scheduling including: secure information (keep all sensitive information for each employee safely in one place), organizational charting (set up organizational charts to eliminate reporting confusion), document uploading, dashboard (employees can stay current on key events, promotions, and metrics by viewing their dashboard), integration (human resource module integrates perfectly with scheduling and timekeeping modules, simple clocking (enter employee number and log a punch type from any device), multiple views (tackle complex schedules easily using your favorite views), time-off requests (request, approve, and track time-off requests), time changing (submit or approve time-change forms on the fly), dashboard, shift builder (build shifts—create work shifts by role and location), define employee roles (define employee roles and assign staff for scheduling), anywhere access (build schedules at work, from home or on the road), scheduling (reach desired capacity levels days, weeks, months or longer, in advance), roles and locations (assign each employee to a predefined role & location), increase accountability (send employees instant updates so they always know when they work), and easy changes (never worry about keeping track of random time-off and shift change requests).

It is an objective of the present disclosure to provide an improved system and method for managing operational hardware of entertainment parks in a cloud-based environment, including a cloud-based park management server having a processor and a memory, wherein the memory comprises a park management program having instructions that are executable on the processor operable to provide improved business analytics, including: daily transactions (track daily sales with register summaries and sales history reports), membership management (follow overall growth or shrinkage and set markers to follow impact of promotions and campaigns), inventory management, employee timekeeping, custom filters (view any report exactly with custom filtering), and report exporting.

It is an objective of the present disclosure to provide an improved system and method for managing operational hardware of entertainment parks in a cloud-based environment, including a cloud-based park management server having a processor and a memory, wherein the memory comprises a park management program having instructions that are executable on the processor operable to control peripheral devices connected to local park gateway devices, typically located at a POS.

It is an objective of the present disclosure to provide an improved system and method for managing operational hardware of entertainment parks in a cloud-based environment, including a cloud-based park management server having a processor and a memory, wherein the memory comprises a park management program having instructions that are executable on the processor operable to control peripheral devices connected to local park gateway devices using one of a first communications protocol and a second communications protocol, dependent on network stability and latency.

It is an objective of the present disclosure to provide an improved system and method for managing operational hardware of entertainment parks in a cloud-based environment, including a cloud-based peripheral device management server having a processor and a memory, wherein the memory comprises a peripheral device management program executable by the processor to handle calls to and from the attached processor-based computing devices, routes the calls to the appropriate destination, and tracks the performance of both the communication channels and that of the hardware.

It is an objective of the present disclosure to provide an improved system and method for managing entertainment parks in a cloud-based environment, including a cloud-based peripheral device management server having a processor and a memory, wherein the memory comprises a peripheral device management program executable by the processor to route commands to peripheral devices and manage peripheral devices using one of a web socket gateway protocol or a service bus protocol, dependent on network stability and latency.

It is an objective of the present disclosure to provide an improved system and method for managing operational hardware of entertainment parks in a cloud-based environment, including a cloud-based peripheral device management server having a processor and a memory, wherein the memory comprises a peripheral device management program executable by the processor to route commands to peripheral devices and manage peripheral devices using one of a plurality of protocols based upon network stability and latency.

It will be appreciated that the cloud-based park management system disclosed herein allows for internet-based computing that provides shared computer processing resources and data to computers and other devices on demand to park operators.

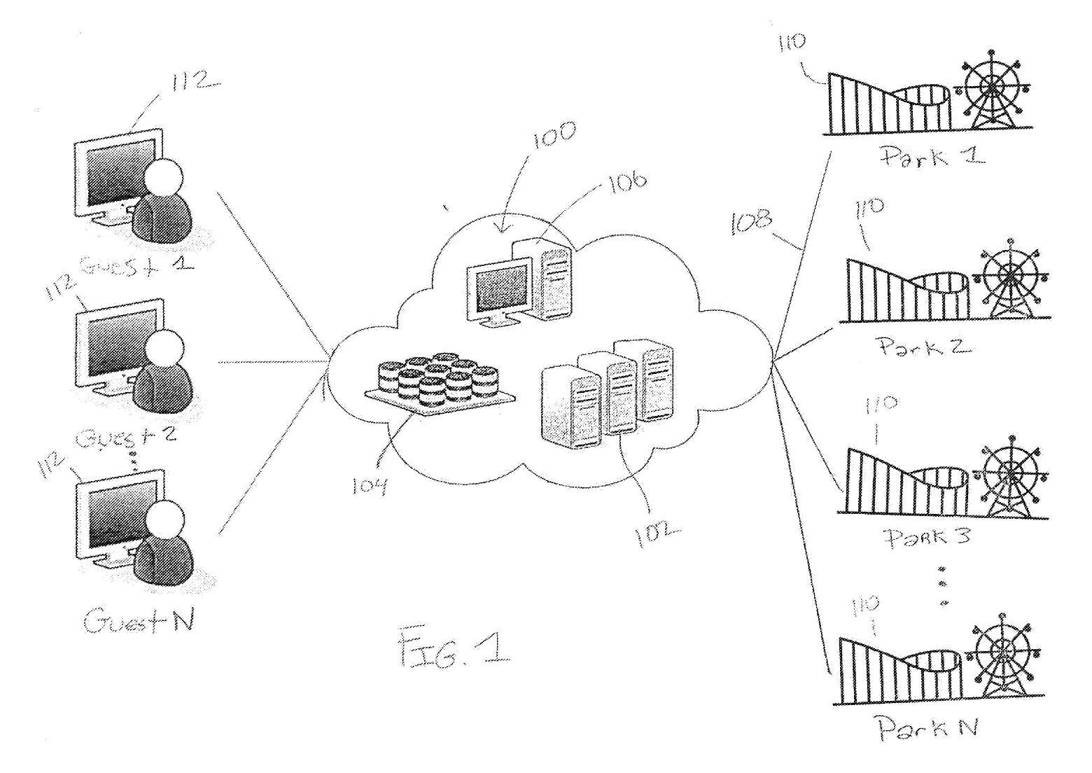

Referring now to FIG. 1, there is generally depicted a cloud-based park management architecture according to an embodiment of the present disclosure that comprises a centralized park management system 100. In an embodiment, the system 100 comprises at least one park management server 102 connected to a data storage device 104. The data storage device 104 may contain a database for storing operational and system data necessary to perform the functions and features as described herein and as is known to a person having ordinary skill. The system 100 may further comprise an administrator computer 106 that allows an administrator to manage the system 100 through a web portal or some other user interface application provided by the park management server 102. In an embodiment, the system 100 may provide a cloud-based set of modules, applications and features needed to run a park efficiently, including, without limitation, ticketing, point of sale, e-commerce, membership management, event management, inventory tracking, human resources, employee timekeeping, sales and marketing, guest portal, and waiver management.

The system 100 may be connected to the operational processor-based devices (not shown) of at least one park 110 over a network 108. In an embodiment, the network 108 is the Internet. As shown, the system 100 may provide services to multiple independently operated parks 110. In an embodiment, the parks 110 may include the operational processor-based devices of water parks, theme parks, amusement parks, museums, concert venues, stadiums, arenas, halls, performance places, studios, parks, event venues, theatres, ski areas, family fun centers, restaurants, water parks, zoos & aquariums and other entertainment locations attended by guests.

The system 100 may also be connected to a plurality of guest computing devices 112 operated by park guests over the network 108. In an embodiment, the guest computing devices 112 may be processor-based computing devices, including smart phones, desktop computers, laptop computers, tablet computers, or any other network-enabled computing device. In an embodiment, the system 100 may host a password protected website that allows park guests to access the guest features provided by the system 100 as will be further explained herein. In an embodiment, the park guests may enroll as a member for one or more of the parks 110 through the website hosted by the system 100. As part of the enrollment process, the park guests may select one of the parks 110 and provide personal information to establish a guest account on the system 100 for the selected one of the parks 110. The guest account information may be stored in a database residing on the data storage device 104.

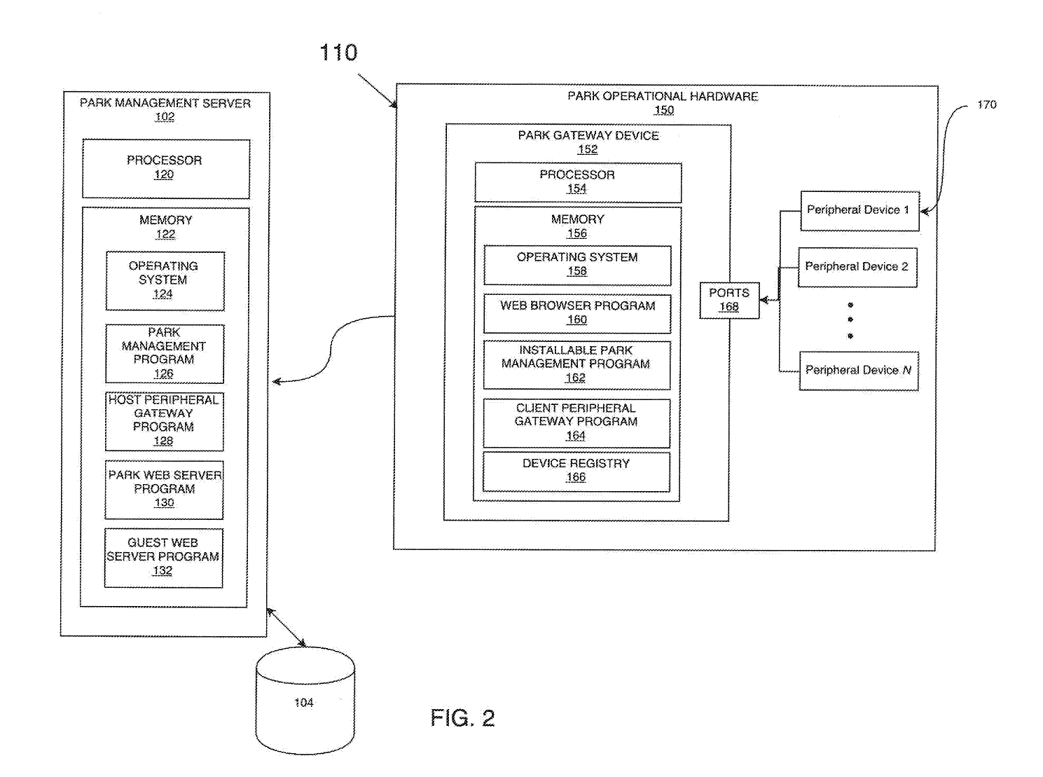

Referring now to FIG. 2, there is depicted the park management server 102 in communication with park operational hardware 150 of a park 110. The park operational hardware 150 may include at least one park gateway device 152. It will be appreciated that in its simplest form, the park gateway device 152 may be any processor-based computing device that is able to connect to a computer network, such as the Internet. In an embodiment the park gateway device 152 may be a smart phone or a tablet computer. The park gateway device 152 may further be a processor-based point-of-sale device or a processor-based access control device. In an embodiment, the park gateway device 152 may be one of a desktop computer, a laptop computer, or any other computing device. The park gateway device 152 may be connected to one or more peripheral devices 170.

In an embodiment, the park management server 102 may include a processor 120 coupled to a computer memory 122. The computer memory 122 may store various computer programs with computer-readable instructions that are executable by the processor 120. The computer memory 122 may store an operating system program 124 as is known to one of ordinary skill. The computer memory 122 may further store a park management program 126, a host peripheral gateway program (“host PGP”) 128, a park web server program 130, and a guest web server program 132. The processor 120 of the park management server 102 is further connected to the data storage device 104. It will be appreciated that the computer memory 122 is a non-transient computer-readable storage medium. In this regard, the non-transient computer-readable storage medium may comprise one of RAM, ROM, optical storage devices, hard drives, USB devices and the like.

In an embodiment, the park management program 126, when executed by the processor 120, provides the park management features to the park gateway device 152 from a cloud-based platform. In an embodiment, these features include point of sale features, e-ticketing features, e-commerce features, gift card management features, and RFID access features. In an embodiment, the features provided by the park management program 126 further include membership management features, event booking features, hardware management features, inventory management features, sales and marketing features, and waiver management features. In an embodiment, these features further include human resource features, including HR management, shift management, employee scheduling, and time keeping. In an embodiment, the features further include analysis and reporting features, including reports and analysis of sales, inventory, registers, staffing and membership.

In an embodiment, the host PGP 128, when executed by the processor 120, handles the communication between the peripheral devices 170 connected to the park gateway device 152 and the park management server 102. For example, the host PGP 128 handles calls to and from the park gateway device 152, routes the calls to the appropriate park gateway device 152 and peripheral devices 170, and tracks the performance of both the communication channels and that of the park gateway device 152. In an embodiment, the host PGP 128 utilizes two different communication protocols to route commands and management activities with the park gateway device 152 and peripheral devices 170.

First, the host PGP 128, when executed by the processor 120, may utilize a web socket gateway protocol to communicate with the park gateway device 152 to thereby control a connected peripheral device 170. This synchronous communication protocol is employed when the host PGP 128 determines that a network connection between park management server 102 and the park gateway device 152 is found to be stable and have low latency. It will be appreciated that the speed of command delivery is greatly increased when a web socket gateway protocol is employed. Under this protocol, the host PGP 128 assumes delivery of the commands to the park gateway device 152. Second, the host PGP 128 may utilize a service bus protocol to communicate with the park gateway device 152. This asynchronous communication protocol is utilized when the host PGP 128 determines the network connection to be unstable or if the network connection is experiencing high latency. However, this protocol guarantees that command delivery occurs at the expense of speed of delivery. Thus, it will be appreciated that the host PGP 128 selects the communication protocol to send communications to the park gateway device 152 based upon the stability and/or latency of the network connection. In this regard, the host PGP 128 may monitor the stability and/or latency of the network connection.

The park web server program 130 is operable to provide web pages of a website hosted by the park management server 102 to a web browser running on the park gateway device 152. In an embodiment, the web pages may provide a user interface for users to interact with the park management program 126. The web pages may provide the ability for users to access and use the features provided by the park management program 126. For example, one or more of the web pages may provide a virtual, web-based point of sale that allows users to conduct transactions with park guests, including ticket sales, product sales, concession sales and other types of transactions. The web pages served by the park web server program 130 may further include virtual and interactive objects that allow users to call on the services of, or command one of, the peripheral devices 170. For example, the web pages may include virtual and interactive buttons that allow a user to complete transactions with users. When selected, the virtual buttons may initiate commands to control the peripheral devices 170. For example, if the peripheral device 170 is a cash drawer, the command initiated by a user through an interactive object on the web page may be to open the cash drawer.

The guest web server program 132 may provide web pages of a guest website hosted by the park management server 102. The guest website is made available to guests using a web browser on the guest computing devices 112 (FIG. 1). It will be appreciated that the guest web server program 132 allows guests to complete online transactions, manage memberships, and reserve facilities at a park 110.

The park gateway device 152 may include a processor 154 coupled to a computer memory 156. The computer memory 156 may store various computer programs with computer-readable instructions that are executable by the processor 154. The computer memory 156 may store an operating system program 158 as is known to one of ordinary skill. The memory 156 may further store a web browser program 160, an installable park management program 162, a client peripheral gateway program (“client PGP”) 164, and a peripheral device registry 166. It will be appreciated that the computer memory 156 is a computer-readable storage medium.

The park gateway device 152 further includes communication ports 168 for providing communications with the peripheral devices 170. That is, the ports 168 provide an interface or a point of connection between the park gateway device 152 and its peripheral devices 170. In an embodiment, the ports 168 may be divided into two types based on the type or protocol used for communication, namely, serial ports and parallel ports. As known to those having ordinary skill, a serial port is an interface through which peripherals can be connected using a serial protocol that involves the transmission of data one bit at a time over a single communication line. A parallel port, on the other hand, is an interface through which the communication between a computer and its peripheral device is in a parallel manner, i.e., data is transferred in or out in parallel using more than one communication line or wire. A printer port is a typical example of a parallel port. In an embodiment, the ports 168 may comprise, without limitation, one of the following port types: PS/2, serial port, DE-9, DB-25, RS-232, COM Port, parallel port, Centronics 36 Pin Port, USB ports, mini-USB ports, RJ-45, and RJ-11.

The operating system program 158 of the park gateway device 152 may be any suitable operating system as is known to one of ordinary skill. Likewise, the web browser program 160 may be any suitable web browser program known to one of ordinary skill. A user may interact with the web browser program 160 to request web pages from the park management server 102 and, in particular, the park web server program 130. As explained above, the web browser program 160 may display web pages that allow park personnel to perform park-related functions necessary for the operation of the park 110. For example, through the web browser program 160 and the web pages provided by the park management server 102, a user may complete transactions with park guests. Moreover, through the web browser program 160 and the web pages provided by the park management server 102, a user may initiate commands to control the peripheral devices 170. For example, a user may initiate a command through the web browser program 160 to open a cash drawer in order to complete the transaction with a guest. Other commands initiated through the web browser program 160 may include print commands. In an embodiment, the commands to control the peripheral devices 170 may be manually initiated by a user or automatically initiated through a script running on the web browser program 160.

The commands initiated through the web browser program 160 on the park gateway device 152 are transmitted to the park management server 102. The commands are then routed to the appropriate one of the peripheral devices 170 as will be explained in more detail hereinafter.

The installable park management program 162 may provide similar functionality as provided by the web browser program 160 and the web pages provided by the park web server program 130. The primary difference is that the installable park management program 162 is an application that is running locally on the park gateway device 152. That is, the installable park management program 162 does not run within the web browser program 160. The installable park management program 162 may provide a graphical user interface that provides park management features. A user may send commands to control one of the peripheral devices 170 to the park management server 102 through the installable park management program 162 running on the park gateway device 152. The processing and routing of these commands by the park management server 102 will be described in more detail hereinafter.

The client PGP 164 is used on the client side to handle the peripheral device commands received from the park management server 102. Additionally, the client PGP 164 scans the peripheral device registry 166 to find and identify the peripheral devices 170 available for control. In an embodiment, the client PGP 164 further scans the communication ports 168 to find and identify available peripheral devices 170.

In an embodiment, the client PGP 164 includes a desktop register module and a peripheral device service module, each of which will now be explained. The desktop register module is used to provide both a register interface and a communications gateway for controlling, sharing, and maintaining peripheral hardware. The client PGP 164 is unique in the fact that its desktop register module can directly make commands to the peripheral hardware without invoking the park management server 102. The desktop register module of the client PGP 164 is used for performance and stability purposes as it also allows for the routing of commands from other sources to the hardware it claims and controls. Additionally, the desktop register module can route commands for controlling duplicative redundant hardware located outside of its control for the purpose of failover.

The peripheral service module is installed onto the memory 156 of the park gateway device 152 as a service to auto scan, claim, and control peripheral devices attached to the device 152. The peripheral service module does not provide a user interface for the purpose of sending commands, but instead acts as the identifier and controller of the peripheral devices 170 attached to the park gateway device 152. In an embodiment, there is also another service that monitors the service provided by the peripheral service module to ensure the health of that service.

It will be appreciated that the host PGP 128 and the client PGP 164 are employed for the purpose of claiming, controlling and sharing hardware throughout an organization, such as an entertainment park. It will be appreciated that these programs 128 and 164 reduce the hardware costs for an organization by reducing the number of peripheral devices needed. Additionally, the hardware (peripheral devices) purchased can be of an older technology and cost since the Internet connectivity is handled by the host PGP 128 and the client PGP 164. It will be appreciated that this technique reduces the number of peripheral devices that require advanced microcontrollers. Another benefit of this is a reduction in the number of potential vectors a malicious coder has to exploit on an organization's network. Additionally, this reduction in complexity also reduces the manpower required to configure and manage advanced, expensive, networked peripheral devices.

In an embodiment, the host PGP 128 and the client PGP 164 also allow for failover hardware to be assigned to registers and access control points. In the event that a peripheral device 170 becomes inoperable, a call to the centralized host PGP 128 will route the command to a failover peripheral device 170. This increases the availability of register functions for the organization at no additional financial cost. Further, the host PGP 128 and the client PGP 164 provide remote diagnostic capabilities for non-networked peripheral devices, which reduces the number of manpower hours necessary for the management of the equipment.

In an embodiment, the host PGP 128 and the client PGP 164 provide for three different processes for peripheral device allocation. First, the most granular peripheral device allocation process is by login (or till in more colloquial terms). Peripheral devices are assigned to a particular user so when the user initiates a peripheral device command, the command is routed to the pre-assigned peripheral device, no matter the point of origin. Under the second process, peripheral device allocation may be based upon the park gateway device that is the source of the command. That is, peripheral devices are explicitly pre-assigned to a given park gateway device. When a user initiates a command via a given park gateway device, then the peripheral device pre-assigned to that device is sent the command. Third, the peripheral device allocation may be by IP address. For example, if both A and B peripheral device allocations have not been assigned, then a process tries to identify a gateway for the park gateway device the peripheral device command is issued from. If an applicable peripheral device has been found for the given IP, a command is sent to the applicable park gateway device through the applicable gateway. Lastly, if no peripheral device is assigned and a command is given, a notification is sent informing the user that the command has failed, as there is no peripheral device found for the given command.

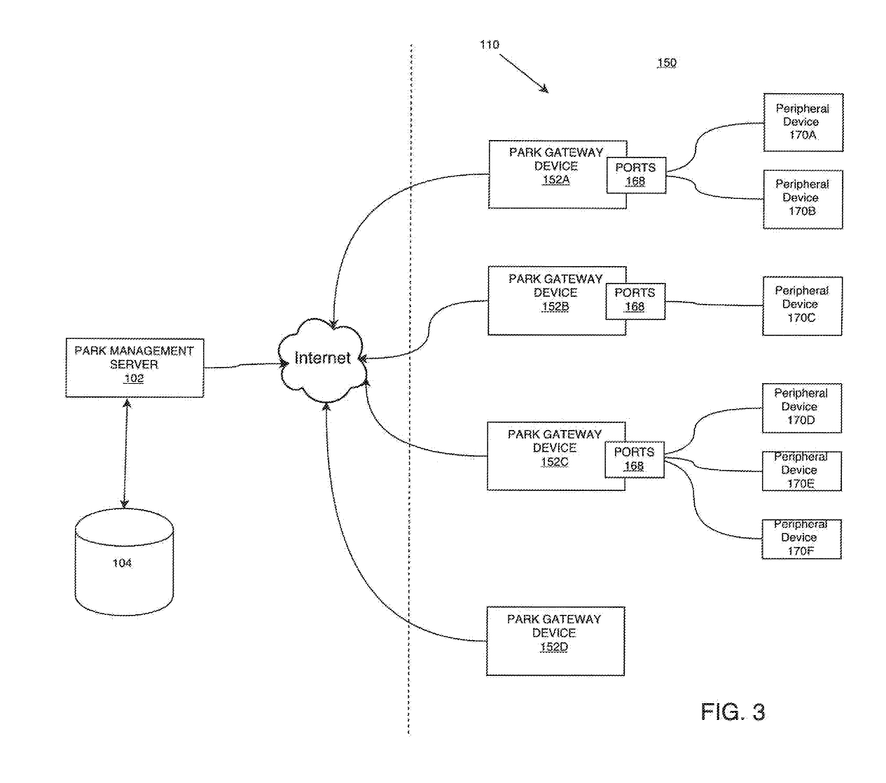

Referring now to FIG. 3, there is depicted an architecture of a cloud-based park management system according to an embodiment of the present disclosure. The park 110 may comprise operational hardware 150 comprising a plurality of park gateway devices 152A-152D. It will be appreciated that the park gateway devices 152A-152D may take the form of the park gateway device 152 shown in FIG. 2. The park gateway device 152A is connected to peripheral devices 170A and 170B through ports 168. The park gateway device 152B is connected to peripheral device 170C. The park gateway device 152C is connected to peripheral devices 170D, 170E, and 170F. The park gateway device 152D is not connected to any peripheral devices. It will be appreciated that the park 110 may include any number of park gateway devices and peripheral devices. The park gateway devices 152A-152D are connected to the park management server 102 over a network, such as the Internet. As previously explained, the park management server 102 provides cloud-based park management features and functions for the park 110.

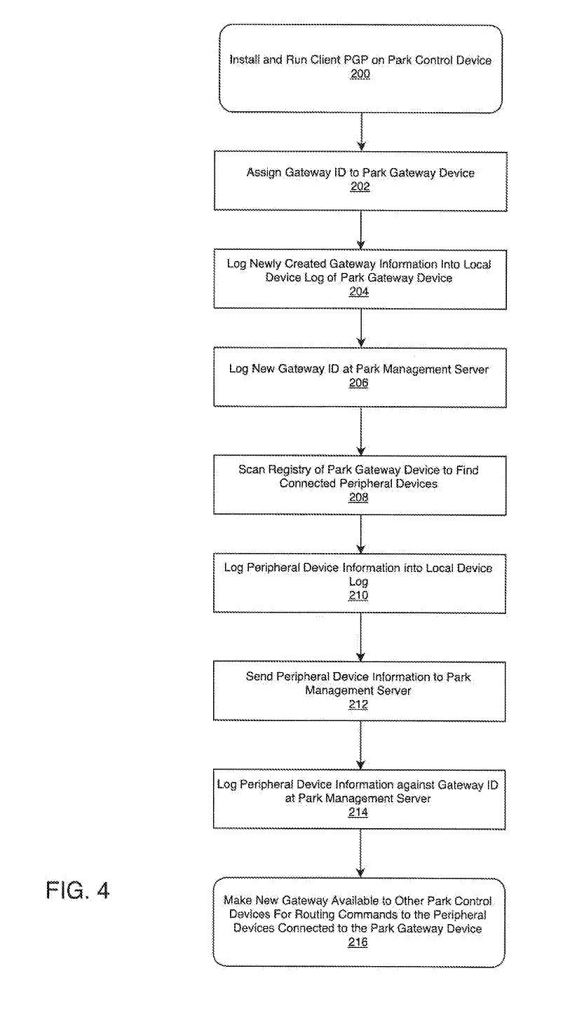

Referring now to FIGS. 3 and 4, there is depicted a process for initializing and registering the park gateway devices 152 and the peripheral devices 170A-170F with the park management server 102. For purposes of clarity, reference numerals are omitted from this part of the disclosure. At step 200, the client PGP is installed into a memory of a park gateway device. This may be accomplished by a downloading the client PGP from a website on the Internet. Alternatively, the client PGP may be installed into the memory using a portable storage medium, such as a USB drive. Once, installed, the client PGP is executed by the processor of park gateway device. At step 202, a gateway ID is assigned to the park gateway device. Then, at step 204, the gateway information is logged into the local device log of the park gateway device. At step 206, the new gateway ID for the park gateway device is also logged at the park management server.

At step 208, the client PGP scans the device registry of the park gateway device to find connected peripheral devices. The client PGP may also scan the ports of the park gateway device to find connected peripheral devices. Once the connected peripheral devices have been identified, the client PGP sends the peripheral device information to the park control server at step 212. At step 214, the park management server associates the peripheral device information with the gateway ID. At step 216, the new gateway and associated peripheral devices are made available to other park gateway devices of the park. Thus, other park gateway devices not locally connected to the peripheral devices can command the peripheral devices connected to the park gateway device.

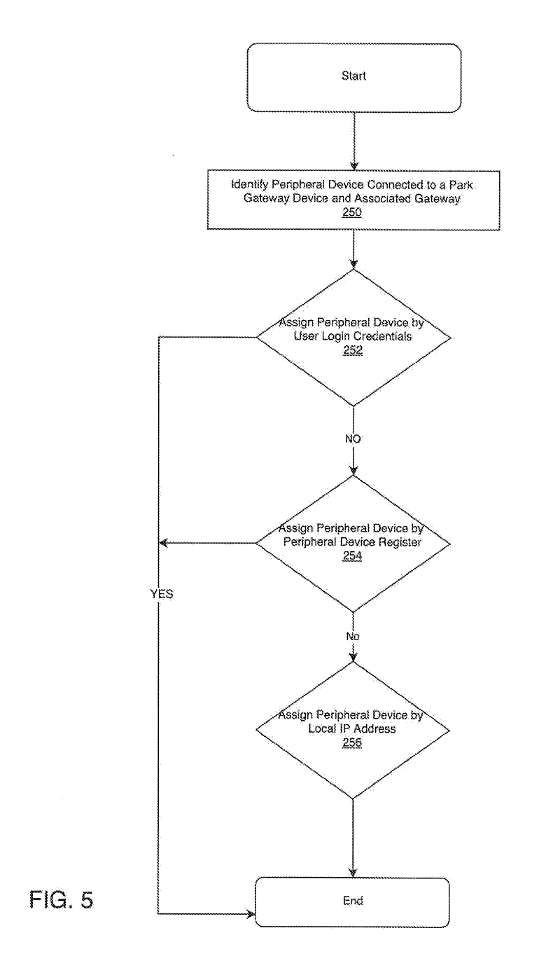

Referring now to FIGS. 3 and 5, there is depicted a process for assigning the peripheral devices 170A-170F at the park management server 102. For purposes of clarity, reference numerals are omitted from this part of the disclosure. At step 250, a peripheral device connected to a park gateway device and its associated gateway are selected. At step 252, if the peripheral device is assigned by user login credentials then the process ends. Peripheral devices are assigned to an individual's login credentials so when the individual initiates a command, the command is routed to the assigned peripheral device, no matter the point of origin.

If not, then, at step 254, the peripheral device is assigned by the peripheral device register/module and the process ends. Peripheral devices are explicitly assigned to a given register/module for performing the command. When a user initiates a command via the register, then the peripheral device assigned to that register is sent the command.

If not, then, at step 256, the peripheral device is assigned by local IP address then the process ends. If both A and B hardware allocations have not been assigned, then the process tries to identify a gateway for the device the hardware command is issued from. It the applicable peripheral device is found for the given IP, a command is sent to that device through the applicable gateway.

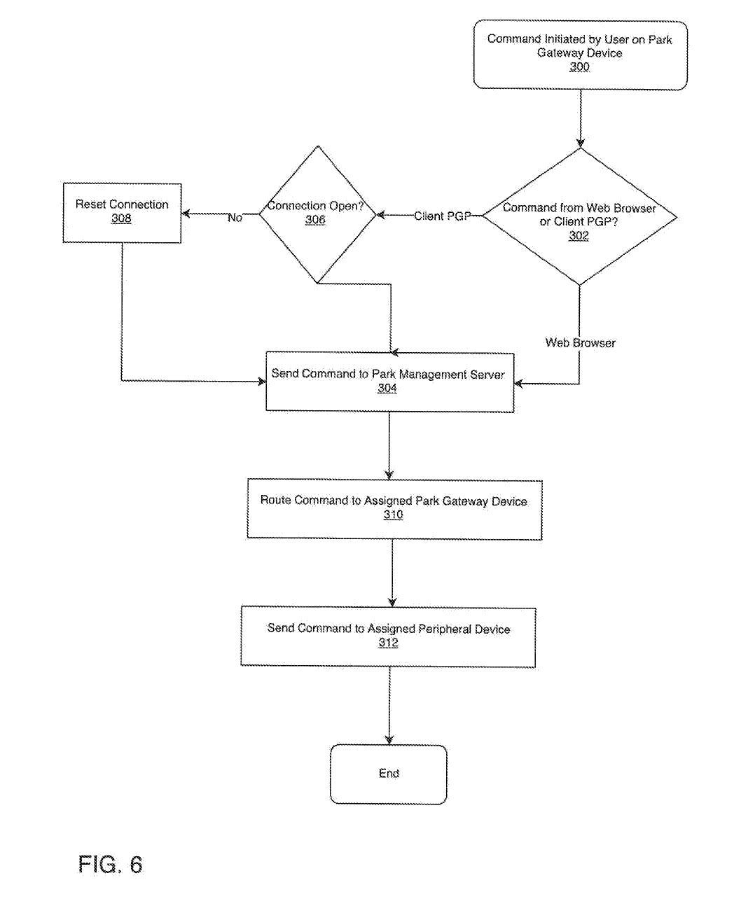

Referring now to FIGS. 3 and 6, there is depicted a process for controlling one of the peripheral devices 170A-170F using the park management server 102. For purposes of clarity, reference numerals are omitted from this part of the disclosure. At step 300, a command is initiated by a user on an originating park gateway device. At step 302, the process determines whether the command is initiated from a web browser or an installable program running on the originating park gateway device. If the command was initiated from an installable program, the process checks whether the connection to the park management server is open or if it needs to be reset at steps 306 and 308. Once the connection is confirmed open, the process sends the command to the park management server at step 304. Alternatively, if the command is initiated in a web browser, then the command is sent to the park management server at step 304. Once the command is received, then, at step 312, the park management server selects the proper gateway for the assigned peripheral device and sends the command to the park gateway device connected to the assigned peripheral device through the gateway. The park management server may send the command to the park gateway device using a web socket protocol or a service bus protocol depending on the stability and latency of the network connection. In particular, the web socket protocol may be utilized if the network connection is determined to be stable and low latency. However, if the network connection is unstable and has high latency, then the service bus protocol may be utilized to send the command to the proper park gateway device.

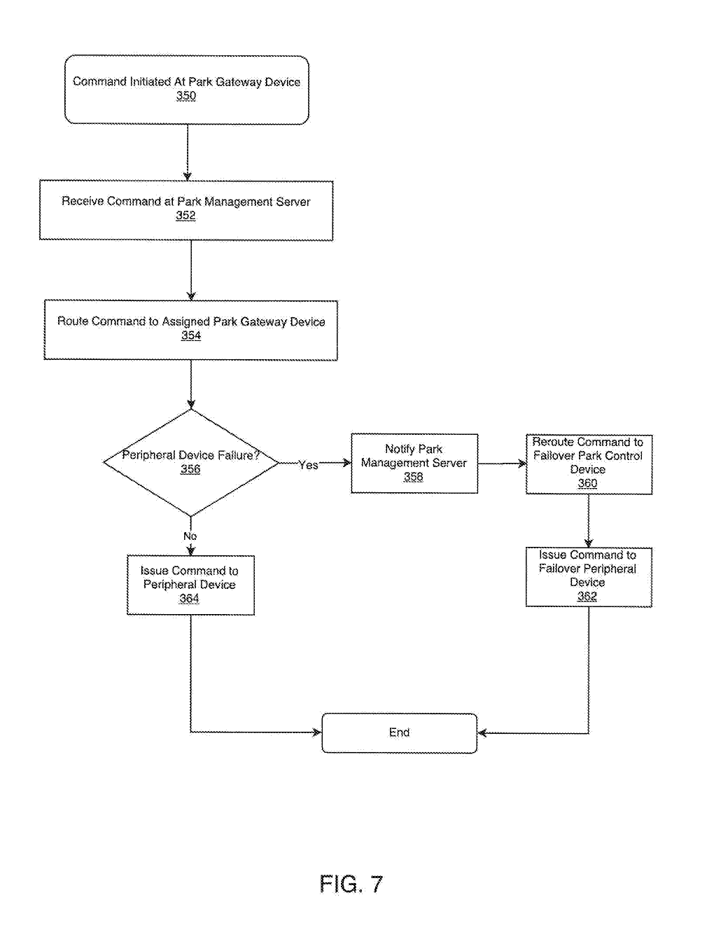

Referring now to FIGS. 3 and 7, there is depicted a process for failover protection in the event that one of the peripheral devices 170A-170F fails. For purposes of clarity, reference numerals are omitted from this part of the disclosure. At step 350, a user initiates a peripheral device command at an originating park gateway device. At step 352, the command is sent to and received at the park management server. Then, at step 354, the park management server routes the command through the appropriate gateway and to the assigned peripheral device connected to a destination park gateway device. If the destination park gateway device determines a peripheral device failure at step 356, then at step 358, the park management server is notified of the failure. Then, at step 360, the park management server reroutes the command to a failover park gateway device. The failover park gateway device then issues the command to the failover peripheral device at step 362. Alternatively, if at step 356 there is no peripheral device failure, then, at step 364, the destination park gateway device issues the command to the connected peripheral device.

Referring back to FIG. 3, it will be appreciated that using the above described embodiments, that the park gateway devices 152A-152D may collectively share the peripheral devices 170A-170F through the park management server 102. For example, commands initiated at the park gateway device 152D may be routed by the park management server 102 to any of the peripheral devices 170A-170F based upon assignments stored at the park management server 102. The park management server 102 may reroute the commands to the appropriate park gateway device 152A-152C using a web socket gateway protocol or a service bus protocol. The park management server 102 may select the communication protocol based upon network stability and latency. In this regard, the park management server 102 tracks the performance of both the communications protocols and the hardware.

Thus, the present disclosure provides a system for managing entertainment parks, said system comprising: a cloud-based centralized park management system comprising at least one server, a computer memory and a database, the centralized server having at least one processor; a park management program stored in the computer memory, the park management program comprising instructions, that, when executed the at least one processor, cause the processor to provide park management features over a network; at least one computer associated with an entertainment park connected to the centralized server and database, the at least one computer able to access and utilize the park management features; wherein the centralized management system provides park operations functions to the at least one computer over a network.

The present disclosure further provides a method of remotely controlling a peripheral device comprising: receiving a command at a management server to control the peripheral device over a network from an originating gateway device, the management server having a memory and a processor; processing the command at the management server using the processor to determine a destination gateway device for the command, the destination gateway device being connected to the peripheral device; selecting between one of a first communication protocol and a second communication protocol using the processor of the management server based upon one of a stability and latency of a network connection between the management server and the destination gateway device; routing the command to the destination gateway device over the network using the selected one of the first communication protocol and the second communication protocol.

The present disclosure further provides a system for remotely controlling a peripheral device, said system comprising: a management server having a processor and memory, the memory comprising computer-readable instructions that, when executed by the processor, cause the processor to: (i) receive a command to control the peripheral device over a network from an originating gateway device; (ii) process the command to determine a destination gateway device for the command, the destination gateway device being connected to the peripheral device; (iii) select between one of a first communication protocol and a second communication protocol based upon one of a stability and latency of a network connection between the management server and the destination gateway device; (iv) routing the command to the destination gateway device over the network using the selected one of the first communication protocol and the second communication protocol.

The present disclosure further provides a non-transient computer-readable medium containing program instructions for causing a computer to perform the method of: receiving a command at a management server to control the peripheral device over a network from an originating gateway device, the management server having a memory and a processor; processing the command at the management server using the processor to determine a destination gateway device for the command, the destination gateway device being connected to the peripheral device; selecting between one of a first communication protocol and a second communication protocol using the processor of the management server based upon one of a stability and latency of a network connection between the management server and the destination gateway device; routing the command to the destination gateway device over the network using the selected one of the first communication protocol and the second communication protocol.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a computing platform, such as a computer or a similar electronic computing device, that manipulates or transforms data represented as physical electronic or magnetic quantities within memories, registers, or other information storage devices, transmission devices, or display devices of the computing platform.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

1. A method of remotely controlling a peripheral device comprising:
receiving a command at a management server to control the peripheral device over a network from an originating gateway device, the management server having a memory and a processor;
processing the command at the management server using the processor to determine a destination gateway device for the command, the destination gateway device being connected to the peripheral device;
selecting between one of a first communication protocol and a second communication protocol using the processor of the management server based upon one of a stability and latency of a network connection between the management server and the destination gateway device;
routing the command to the destination gateway device over the network using the selected one of the first communication protocol and the second communication protocol.

2. The method of claim 1, wherein the first communication protocol is a web socket protocol.

3. The method of claim 1, wherein the first communication protocol is a service bus protocol.

4. The method of claim 1, wherein the first communication protocol is a web socked protocol and the second communication protocol is a service bus protocol.

5. The method of claim 1, wherein the command is originated by a user on the originating gateway device through a webpage displayed in a web browser.

6. The method of claim 1, wherein the peripheral device is one of a printer, digital camera, bar code reader, cash drawer, access control, and credit card reader.

7. The method of claim 1, further comprising selecting between one of the first communication protocol and the second communication protocol using the processor of the management server based upon both the stability and latency of the network connection between the management server and the destination gateway device.

8. The method of claim 1, wherein the originating gateway device is one of a smart phone, desktop computer, laptop computer, and a tablet.

9. The method of claim 1, wherein the peripheral device is connected to the destination gateway device using a computer port.

10. The method of claim 1, wherein the computer port is one of a serial port and a parallel port.

11. The method of claim 1, further comprising assigning the peripheral device to the originating device.

12. A system for remotely controlling a peripheral device, said system comprising:
a management server having a processor and memory, the memory comprising computer-readable instructions that, when executed by the processor, cause the processor to: (i) receive a command to control the peripheral device over a network from an originating gateway device; (ii) process the command to determine a destination gateway device for the command, the destination gateway device being connected to the peripheral device; (iii) select between one of a first communication protocol and a second communication protocol based upon one of a stability and latency of a network connection between the management server and the destination gateway device; (iv) routing the command to the destination gateway device over the network using the selected one of the first communication protocol and the second communication protocol.

13. The system of claim 12, wherein the first communication protocol is a web socket protocol.

14. The system of claim 12, wherein the first communication protocol is a service bus protocol.

15. The system of claim 12, wherein the first communication protocol is a web socked protocol and the second communication protocol is a service bus protocol.

16. The system of claim 12, wherein the command is originated by a user on the originating gateway device through a webpage displayed in a web browser.

17. The system of claim 12, wherein the peripheral device is one of a printer, digital camera, bar code reader, cash drawer, access control, and credit card reader.

18. The system of claim 12, wherein the originating gateway device is one of a smart phone, desktop computer, laptop computer, and a tablet.

19. The system of claim 12, wherein the peripheral device is connected to the destination gateway device using a computer port.

20. A non-transient computer-readable medium containing program instructions for causing a computer to perform the method of:
receiving a command at a management server to control the peripheral device over a network from an originating gateway device, the management server having a memory and a processor;
processing the command at the management server using the processor to determine a destination gateway device for the command, the destination gateway device being connected to the peripheral device;
selecting between one of a first communication protocol and a second communication protocol using the processor of the management server based upon one of a stability and latency of a network connection between the management server and the destination gateway device;
routing the command to the destination gateway device over the network using the selected one of the first communication protocol and the second communication protocol.
